(19) United States
(12) Patent Application Publication
(10) Pub. No.: US 2017/0130081 A1
(43) Pub. Date: May 11, 2017

(54) INK, PRINTED MATTER, INK STORED CONTAINER, PRINTING APPARATUS, AND PRINTING METHOD

(71) Applicants: Kaori TOYAMA, Kanagawa (JP); Yuuki Yokohama, Kanagawa (JP); Hiromi Sakaguchi, Kanagawa (JP); Hideaki Nishimura, Kanagawa (JP); Masayuki Fukuoka, Tokyo (JP); Hiroshi Gotou, Shizuoka (JP)

(72) Inventors: Kaori TOYAMA, Kanagawa (JP); Yuuki Yokohama, Kanagawa (JP); Hiromi Sakaguchi, Kanagawa (JP); Hideaki Nishimura, Kanagawa (JP); Masayuki Fukuoka, Tokyo (JP); Hiroshi Gotou, Shizuoka (JP)

(21) Appl. No.: 15/277,598

(22) Filed: Sep. 27, 2016

(30) Foreign Application Priority Data
Nov. 6, 2015 (JP) 2015-218611
Feb. 1, 2016 (JP) 2016-017258

(51) Int. Cl. C09D 11/107; C09D 11/36; C09D 11/322; B41J 2/14; C09D 11/102

(52) U.S. Cl. CPC C09D 11/107; B41J 2/14; C09D 11/102; C09D 11/322; C09D 11/36

(57) ABSTRACT

Provided is an ink including water, at least one organic solvent, a coloring material, urethane-based resin particles, and acrylic-based resin particles, wherein a difference between a total HSP value of an organic solvent having the highest boiling point of the at least one organic solvent and a total HSP value of the urethane-based resin particles is 6.0 [(J/cm³)^{0.5}] or less, and wherein a difference between a polarity HSP value of the organic solvent having the highest boiling point of the at least one organic solvent and a polarity HSP value of the urethane-based resin particles is 5.0 [(J/cm³)^{0.5}] or less.

### CROSS-REFERENCE TO RELATED APPLICATIONS

The present application claims priority under 35 U.S.C. §119 to Japanese Patent Application No. 2015-218611, filed Nov. 6, 2015 and Japanese Patent Application No. 2016-017258, filed Feb. 1, 2016. The contents of which are incorporated herein by reference in their entirety.

### BACKGROUND OF THE INVENTION

Field of the Invention

The present disclosure relates to an ink, a printed matter, an ink stored container, a printing apparatus, and a printing method.

Description of the Related Art

Inkjet printing systems are printing systems configured to discharge ink droplets directly onto print media from extremely minute nozzles to attach the ink droplets to the print media and obtain texts and images. There are advantages that apparatuses employing the systems produce less noise, are easy to operate, can be easily accommodated to color operations, and can use plain paper as print media. Therefore, the systems are widely used as output machines in offices and households.

In the meantime, along with improvement in the inkjet technologies, use for industrial purposes as output machines for digital printing is also expected of the systems. Actually, printers capable of printing images on non-absorbable bases using solvent inks or UV inks have been sold on the market. However, in recent years, demands for water-based inks have been increasing from environmental concerns.

As water-based inks for inkjetting, inks for exclusive use on plain paper or dedicated paper such as photo glossy paper have been developed from way before. Meanwhile, recently, applicable purposes of the inkjet printing systems have been expected to expand, and needs for printing on coated paper such as coat paper have been increasing. However, it is difficult to fix pigments firmly on poorly permeable media such as coat paper. As in Japanese Unexamined Patent Application Publication No. 2013-248883, a means may be taken to coat an ink layer with a post-processing fluid to protect the ink layer and secure fixability. However, this makes printing apparatuses large in size and increases costs. Hence, there is a need for obtaining images having a good fixability without a post-processing step.

Improvement of fixability is also possible by addition of a resin as in Japanese Unexamined Patent Application Publication No. 2010-024352. The kinds of resins suitable for use are said to be acrylic-based resins in terms of durabilities of the printed matters. However, with acrylic-based resins alone, it has not been able to obtain a sufficient fixability. This is considered due to the characteristic of the acrylic of becoming hard and brittle when cured.

Hence, a method of adding a urethane-based resin having a high elasticity as compensation for the brittleness of the acrylic to improve fixability is employed (see, e.g., Japanese Unexamined Patent Application Publication No. 2004-131586). The publication describes that addition of an acrylic-based resin and a urethane-based resin results in excellent scratch resistance, excellent light resistance, and excellent storage stability, and that depending on the conditions, addition of a urethane resin instead of an acrylic resin alone results in an improved glossiness.

### SUMMARY OF THE INVENTION

According to one aspect of the present disclosure, an ink including water, at least one organic solvent, a coloring material, urethane-based resin particles, and acrylic-based resin particles is provided.

A difference between a total HSP value of an organic solvent having the highest boiling point of the at least one organic solvent and a total HSP value of the urethane-based resin particles is 6.0 [(J/cm³)^{0.5}] or less.

A difference between a polarity HSP value of the organic solvent having the highest boiling point of the at least one organic solvent and a polarity HSP value of the urethane-based resin particles is 5.0 [(J/cm³)^{0.5}] or less.

### BRIEF DESCRIPTION OF THE DRAWINGS

FIG. 1 is a perspective view exemplarily illustrating an example of a printing apparatus according to an embodiment of the present disclosure; and

FIG. 2 is a perspective view exemplarily illustrating an example of an ink cartridge according to an embodiment of the present disclosure.

### DESCRIPTION OF THE EMBODIMENTS

An ink, a printed matter, an ink cartridge, a printing apparatus, and a printing method of the present disclosure will be described below with reference to the drawings. The present disclosure should not be construed as being limited to an embodiment described below, but other embodiments, additions, modifications, deletions, etc. may be made within a conceivable scope of persons with ordinary skill in the art. Any embodiments that have the working and effects of the present disclosure are intended to be included within the scope of the present disclosure.

The present disclosure provides an ink including water, at least one organic solvent, a coloring material, urethane-based resin particles, and acrylic-based resin particles. A difference between a total HSP value of an organic solvent having the highest boiling point of the at least one organic solvent and a total HSP value of the urethane-based resin particles is 6.0 [(J/cm³)^{0.5}] or less. A difference between a polarity HSP value of the organic solvent having the highest boiling point of the at least one organic solvent and a polarity HSP value of the urethane-based resin particles is 5.0 [(J/cm³)^{0.5}] or less.

The present disclosure also provides an ink including water, at least one organic solvent, a coloring material, urethane-based resin particles, and acrylic-based resin particles. A solid image formed with the ink has a surface roughness Ra of 6.0 [μm] or greater but 7.5 [μm] or less when formed in a manner that the ink is attached in an amount of from 500 mg through 700 mg/A4 on a print medium that includes a coated layer on a support including cellulose pulp and has a surface roughness of 7.0 [μm] or greater but 10.0 [μm] or less.

The present disclosure has an object to provide an ink having an excellent fixability and a high glossiness.

The ink of the present disclosure is based on the following finding. Specifically, about existing inks including acrylic-based resins and urethane-based resins, it is known that acrylic-based resins tend to express a high glossiness because acrylic-based resins have characteristics of becoming harder than urethane-based resins when formed into films, although addition of urethane-based resins tends to reduce glossiness. Hence, as in Japanese Unexamined Patent Application Publication No. 2012-207202, use of a urethane-based resin is accompanied by combined use of a wax to secure glossiness. However, there is a problem that use of a wax tends to result in deposition of the wax on surfaces of printed matters to deteriorate appearance.

As a result of the present inventors' studies in which glossiness vs. surface roughness Ra in use of acrylic-based resin particles and in use of urethane-based resin particles was measured, it was confirmed that acrylic-based resin particles resulted in a higher glossiness even when both kinds of the resins had the same surface roughness, and it was found that when urethane-based resin particles and acrylic-based resin particles were to be used in combination, there was a need for greater improvement of a leveling property to suppress surface roughness of an image to be formed on a print medium.

Specifically, the surface roughness Ra is preferably 6.0 [μm] or greater but 7.5 [μm] or less, more preferably 6.3 [μm] or greater, and particularly preferably 6.5 [μm] or greater. The reason is as follows. When the surface roughness Ra is greater than 7.5 [μm], glossiness to be obtained is not greater than glossiness obtained on coat paper and is not sufficient. When the surface roughness Ra is less than 6.0 [μm], printed matters overlapped with each other have an insufficient clearance between the printed matters and have close adhesiveness to worsen blocking resistance.

It was impossible to achieve this range of a surface roughness Ra only by mixing urethane-based resin particles with acrylic-based resin particles. The reason for this is uncertain but considered due to difference between acrylic-based resin particles and urethane-based resin particles in solubility, leading to difference in leveling property. Hence, earnest studies about the following matters were conducted, and as a result, reached the present invention and made it possible to satisfy both of glossiness and fixability at the same time.

In the present disclosure, the surface roughness Ra is measured according to a method specified in JISB-0601 using LEXT OLS4100 (available from Olympus Corporation). The measurement is performed under the conditions that a measuring length is 2.5 mm and a cutoff value is 0.8 mm.

### <Ink>

The organic solvent, water, coloring material, resin and additives for use in the ink are described next.

### <Organic Solvent>

As a result of the present inventors' studies for satisfying the physical property described above, it was found important to specify HSP values of an organic solvent, urethane-based resin particles, and acrylic-based resin particles.

Although depending on the kinds of the resins used, it is important for the organic solvent used in the present disclosure that a difference between a total HSP value of the organic solvent and a total HSP value of the urethane-based resin particles be 6.0 [(J/cm³)^{0.5}] or less, and that a difference between a polarity HSP value of the organic solvent and a polarity HSP value of the urethane-based resin particles be 5.0 [(J/cm³)^{0.5}] or less.

In use of a plurality of kinds of organic solvents, the difference is between a HSP value of a solvent that has the highest boiling point and evaporates the most lastly and a HSP value of the urethane-based resin particles. That is, the difference between a total HSP value of an organic solvent having the highest boiling point of the plurality of organic solvents and a total HSP value of the urethane-based resin particles is 6.0 [(J/cm³)^{0.5}] or less, and the difference between a polarity HSP value of the organic solvent having the highest boiling point of the plurality of organic solvents and a polarity HSP value of the urethane-based resin particles is 5.0 [(J/cm³)^{0.5}] or less. Note that the difference is the absolute value of the result of subtraction.

When the difference between the HSP values of the organic solvent and the urethane-based resin particles is outside the range described above, a sufficient leveling property may not be obtained, and a solid image formed on the above-described predetermined print medium in the above-described predetermined amount of ink attachment has a surface roughness Ra of greater than 7.5 [μm] and may not have a sufficient glossiness. When the difference between the HSP values of the organic solvent and the urethane-based resin particles is within the range described above, an image formed on the above-described predetermined print medium in the above-described predetermined amount of ink attachment has a surface roughness of 6.0 [μm] or greater but 7.5 [μm] or less.

It is preferable that a difference between the total HSP value of the organic solvent having the highest boiling point of the plurality of organic solvents and a total HSP value of the acrylic-based resin particles be 5.0 [(J/cm³)^{0.5}] or less. When the difference is within this range, the leveling property is improved to suppress the surface roughness. Hence, a suitable glossiness can be obtained.

The HSP value stands for Hansen's solubility parameter, and is an indicator of solubility of a substance. The HSP value is conceptually different from Hildebrand's SP value employed in, for example, ‘Solvent Handbook’ (published by Kodansha Scientific Ltd.). The HSP value represents solubility by multidimensional (typically, three-dimensional) vectors. Representatively, the vectors can be expressed by a dispersion term, a polarity term, and a hydrogen bond term. The dispersion term reflects a Van der Waals force, the polarity term reflects a dipole moment, and the hydrogen bond term reflects an action of, for example, water or an alcohol. The total HSP value is the sum of the three vectors. The HSP value can be calculated with software such as HSPIP. Substances having similar HSP vectors can be judged as having a high solubility to each other. Therefore, when the organic solvent that has the highest boiling point of the organic solvents included and remains until last during drying and fixing of the ink has a HSP value similar to the HSP value of the resin particles, the organic solvent has a good compatibility with the resin particles and mixes well with the resin particles. This is considered to provide a surface of an image during film formation with a good leveling property. Note that even when an organic solvent having a HSP value similar to the HSP value of the urethane resin particles was included in the ink, it was impossible to obtain the effect of the present disclosure when the boiling point of that organic solvent was not the highest of the organic solvents included.

The organic solvents are not particularly limited and may be appropriately changed so long as the difference between the HSP value of the organic solvent having the highest boiling point of the organic solvents included and the HSP value of the urethane-based resin particles is within the range described above. Water-soluble organic solvents are also suitable. Specific examples thereof include, but are not limited to, polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

Among the water-soluble organic solvents presented above, amide compounds or oxetane compounds are particularly preferable as the solvent having the highest boiling point. Use of these compounds enables improvement of strength of a coating film. Moreover, these compounds are excellent in dispersion stability and leveling property because these compounds have HSP values similar to the HSP value of the resin particles. Preferable amide compounds or oxetane compounds are, for example, N,N-dimethyl-β-butoxypropionamide (HSP value: 20.2), N,N-dimethyl-β-methoxypropionamide (HSP value: 22.5), 3-ethyl-3-hydroxymethyloxetane (HSP value: 22.6), and propylene glycol monomethyl ether (1-methoxy-2-propanol) (HSP value: 20.4). Organic solvents having a total HSP value of 20 or greater but 23 or less are preferable.

The boiling point of the organic solvent is preferably 180 degrees C. or higher but 250 degrees C. or lower. When the boiling point of the organic solvent is lower than 180 degrees C., an evaporating speed of the organic solving during drying is high, and leveling may not be effected sufficiently, which may provide the surface with great irregularities and a poor glossiness. Conversely, when the boiling point of the organic solvent is higher than 250 degrees C., a drying property is poor and a long time of drying may be needed. Along with recent advancement of the speed of printing technologies, the time needed for drying the ink has become the rate determining factor, and there is a need for shortening the drying time. Therefore, a long time of drying is unfavorable.

The proportion of the organic solvent in ink has no particular limit and can be suitably selected to suit a particular application. In terms of the drying property and discharging reliability of the ink, the proportion is preferably from 10 through 60 percent by mass and more preferably from 20 through 60 percent by mass.

When the organic solvent includes two or more kinds of organic solvents, an organic solvent having the lowest total HSP value is assumed as solvent A, and an organic solvent having the next lowest total HSP value second to the solvent A is assumed as solvent B. In this case, it is preferable that HSP distances calculated according to the formula below satisfy predetermined values. That is, it is preferable that the HSP distance between the solvent A and the solvent B be 9 or less, and that the HSP distance between water included in the ink and the solvent B be 32 or less.

Rₐ=(4(δ_{D2}−δ_{D1})²+(δ_{P2}−δ_{P1})²+(δ_{H2}−δ_{H1})²)^{0.5}

The symbols in the formula are as follows.

Ra: HSP distance

δ_{D2}: HSP value of solvent B other than polarity HSP value (dispersion HSP value)

δ_{D1}: HSP value of solvent A (or water) other than polarity HSP value (dispersion HSP value)

δ_{P2}: polarity HSP value of solvent B

δ_{P1}: polarity HSP value of solvent A (or water)

δ_{H2}: hydrogen bond HSP value of solvent B

δ_{H1}: hydrogen bond HSP value of solvent A (or water)

When a hydrophobic solvent gets separated from ink solvents, resins are exposed to the hydrophobic solvent and aggregate, which may be a cause of nozzle clogging. Use of solvents that are in the relationship represented by the range described above makes it difficult for a hydrophobic solvent to be separated at nozzle holes and makes it possible to obtain an ink free of nozzle clogging.

The total HSP value described above can be expressed by a formula below.

(δ_{D}²+δ_{P}²+δ_{H}²)^{0.5}

The symbols in the formula are as follows.

δ_{D}: HSP value other than polarity HSP value (dispersion HSP value)

δ_{P}: polarity HSP value

δ_{H}: hydrogen bond HSP value

### <Water>

The proportion of water in the ink has no particular limit and can be suitably selected to suit to a particular application. In terms of the drying property and discharging reliability of the ink, the proportion is preferably from 10 through 90 percent by mass and more preferably from 20 through 60 percent by mass.

### <Coloring Material>

The coloring material has no particular limit. For example, pigments and dyes are suitable.

The pigment includes inorganic pigments and organic pigments. These can be used alone or in combination. In addition, it is possible to use a mixed crystal.

As the pigments, for example, black pigments, yellow pigments, magenta pigments, cyan pigments, white pigments, green pigments, orange pigments, gloss pigments of gold, silver, etc., and metallic pigments can be used.

As the inorganic pigments, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black. Of these pigments, pigments having good affinity with solvents are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4 (Phthalocyanine Blue), 16, 17:1, 56, 60, and 63; and C.I. Pigment Green 1, 4, 7, 8, 10, 17, 18, and 36.

The type of dye is not particularly limited and includes, for example, acidic dyes, direct dyes, reactive dyes, and basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 through 15 percent by mass and more preferably from 1 through 10 percent by mass in terms of enhancement of image density, fixability, and discharging stability.

To obtain the ink, the pigment is dispersed by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group and carboxyl group to the pigment (e.g., carbon) to disperse the pigment in water.

To coat the surface of the pigment with resin, the pigment is encapsulated by microcapsules to make the pigment dispersible in water. This can be referred to as a resin-coated pigment. In this case, the pigment to be added to ink is not necessarily wholly coated with resin. Pigments partially or wholly uncovered with resin may be dispersed in the ink unless the pigments have an adverse impact.

To use a dispersant, for example, a known dispersant of a small molecular weight type or a high molecular weight type represented by a surfactant is used to disperse the pigments in ink.

As the dispersant, it is possible to use, for example, anionic surfactants, cationic surfactants, amphoteric surfactants, nonionic surfactants, etc. depending on the pigments.

Also, a nonionic surfactant (RT-100, manufactured by TAKEMOTO OIL & FAT CO., LTD.) and a formalin condensate of naphthalene sodium sulfonate are suitable as dispersants.

These dispersants can be used alone or in combination.

### <Pigment Dispersion>

The ink can be obtained by mixing the coloring material with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by mixing and dispersing water, pigment, pigment dispersant, and other optional components and adjusting the particle diameter. It is good to use a dispersing device for dispersion.

The particle diameter of the pigment in the pigment dispersion has no particular limit. For example, the maximum frequency in the maximum number conversion is preferably from 20 through 500 nm and more preferably from 20 through 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the proportion is preferably from 0.1 through 50 percent by mass and more preferably from 0.1 through 30 percent by mass.

During the production, coarse particles are optionally filtered off from the pigment dispersion with a filter, a centrifuge, etc. preferably followed by degassing.

### <Resin Particles>

Resins used in the present disclosure are urethane-based resin particles and acrylic-based resin particles. To obtain the ink, the resin particles may be prepared as a resin emulsion dispersed in a dispersion medium, which is water, and then mixed with the materials such as the coloring material and the organic solvent. The resin particles may be appropriately synthesized products or commercially available products. As the urethane-based resin, UCOAT available from DKS Co., Ltd. and TAKELAC available from Mitsui Chemicals, Inc. may be used. As the acrylic-based resin, SYMAC available from Toagosei Co., Ltd., VONCOAT available from DIC CORPORATION, AQUABRID available from Daicel Corporation, and POLYSOL available from Showa Kobunshi Co., Ltd. may be used. As the urethane resin, polycarbonate-based urethane resins are preferable in terms of storage stability and fixability. As the polycarbonate-based urethane resins, for example, TAKELAC WS-4000, W-6010, and W-6110 are available from Mitsui Chemicals, Inc.

It is preferable that the proportion of the acrylic-based resin particles in the ink be greater than the proportion of the urethane-based resin particles in the ink. If the ratio of the urethane-based resin is greater, image surfaces may have a severe tackiness to worsen blocking resistance. More specifically, the ratio of the urethane-based resin particles to the acrylic-based resin particles as expressed in a ratio by mass between solid proportions is preferably from 0.1 through 0.7. Within this range, scratch resistance, discharging stability, and storage stability of the ink can be satisfied at the same time.

The volume average particle diameter of the resin particle is not particularly limited and can be suitably selected to suit to a particular application. The volume average particle diameter is preferably from 10 through 1,000 nm, more preferably from 10 through 200 nm, and furthermore preferably from 10 through 100 nm to obtain good fixability and image hardness.

The volume average particle diameter can be measured by using a particle size analyzer (Nanotrac Wave-UT151, manufactured by MicrotracBEL Corp.).

The proportion of the resin is not particularly limited and can be suitably selected to suit to a particular application. In terms of fixability and storage stability of ink, it is preferably from 1 through 30 percent by mass and more preferably from 5 through 20 percent by mass to the total content of the ink.

The proportion of the urethane-based resin particles is preferably 0.5 percent by mass or greater but 2.0 percent by mass or less of the total amount of the ink. The proportion of the acrylic-based resin particles is preferably 0.5 percent by mass or greater but 2.0 percent by mass or less of the total amount of the ink.

A glass transition temperature Tg of the urethane-based resin particles is preferably −20 [degrees C.] or higher but 70 [degrees C.] or lower. Within this range, a good film forming property is obtained and a good blocking resistance is exhibited even with a short time of drying. A more preferable range of the glass transition temperature Tg of the urethane-based resin particles is −20 [degrees C.] or higher but 25 [degrees C.] or lower.

The particle diameter of the solid portion in ink has no particular limit and can be suitably selected to suit to a particular application. For example, the maximum frequency in the maximum number conversion is preferably from 20 through 1,000 nm and more preferably from 20 through 150 nm to ameliorate the discharging stability and image quality such as image density. The solid portion includes resin particles, particles of pigments, etc. The particle diameter of the solid portion can be measured by using a particle size analyzer (Nanotrac Wave-UT151, manufactured by MicrotracBEL Corp).

### <Additive>

Ink may further optionally contain a surfactant, a defoaming agent, a preservative and fungicide, a corrosion inhibitor, a pH regulator, etc.

### <Surfactant>

As the surfactant, any of silicone-based surfactants, fluorosurfactants, amphoteric surfactants, nonionic surfactants, and anionic surfactants is suitable.

The silicone-based surfactant has no specific limit and can be suitably selected to suit to a particular application. Of silicone-based surfactants, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These fluoro surfactants are particularly preferable because these fluoro surfactants do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination.

The silicone-based surfactants have no particular limit and can be suitably selected to suit to a particular application. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant.

Any suitably synthesized surfactant and any product thereof available on the market is suitable. Products available on the market are obtained from Byk Chemie Japan Co., Ltd., Shin-Etsu Chemical Co., Ltd., Dow Corning Toray Silicone Co., Ltd., etc., NIHON EMULSION Co., Ltd., Kyoeisha Chemical Co., Ltd., etc.

The polyether-modified silicone-based surfactant has no particular limit and can be suitably selected to suit to a particular application. Examples thereof include a compound in which the polyalkylene oxide structure represented by the following general formula S-1 is introduced into the side chain of the Si site of dimethyl polysiloxane.

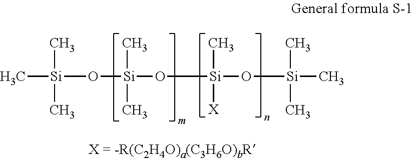

In general formula S-1, “m”, “n”, “a”, and “b” each, respectively represent integers, R represents an alkylene group, and R′ represents an alkyl group.

Products available on the market may be used as the polyether-modified silicone-based surfactants. Specific examples of the products available on the market include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Silicone Co., Ltd.), BYK-33 and BYK-387 (both manufactured by Byk Chemie Japan Co., Ltd.), and TSF4440, TSF4452, and TSF4453 (all manufactured by Toshiba Silicone Co., Ltd.).

A fluorosurfactant in which the number of carbon atoms replaced with fluorine atoms is from 2 through 16 and more preferably from 4 through 16 is preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these fluorosurfactants, polyoxyalkylene ether polymer compounds having a perfluoroalkyl ether group in its side chain are preferable because these compounds do not foam easily and the fluorosurfactant represented by the following general formula F-1 or general formula F-2 is particularly preferable.

CF₃CF₂(CF₂CF₂)ₘ—CH₂CH₂O(CH₂CH₂O)ₙH General formula F-1

In general formula F-1, “m” is preferably an integer of from 0 through 10 and “n” is preferably an integer of from 0 through 40 in order to provide water solubility.

CₙF₂ₙ₊₁—CH₂CH(OH)CH₂—O—(CH₂CH₂O)ₐ—Y General formula F-2

In general formula F-2, Y represents H, CₙH₂ₙ₊₁, where “n” is an integer of from 1 through 6, CH₂CH(OH)CH₂—CₙH₂ₙ₊₁, where n represents an integer of from 4 through 6, or CₚH₂ₚ₊₁, where p represents an integer of from 1 through 19. “a” represents an integer of from 4 through 14.

Products available on the market may be used as the fluorosurfactant. Specific examples of the products available on the market include, but are not limited to, SURFLON S-111, SURFLON S-112, SURFLON S-113, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFAC F-470, F-1405, and F-474 (all manufactured by DIC CORPORATION); ZONYL™ TBS, FSP, FSA, FSN-100, FSN, FSO-100, FSO, FS-300, and UR (all manufactured by Du Pont Kabushiki Kaisha); FP 110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.), and UNIDYNE DSN-403N (manufactured by DAIKIN INDUSTRIES). Of these products, FS-300 (manufactured by Du Pont Kabushiki Kaisha), FT-110, FT-250, FT-251, FT-400S, FT-150, and FT-400SW (all manufactured by NEOS COMPANY LIMITED), POLYFOX PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dyeing property to paper.

The proportion of the surfactant in ink is not particularly limited and can be suitably selected to suit to a particular application. It is preferably from 0.001 through 5 percent by mass and more preferably from 0.05 through 5 percent by mass in terms of excellent wettability and discharging stability and improvement on image quality.

### <Defoaming Agent>

The defoaming agent has no particular limit. For example, silicon-based defoaming agents, polyether-based defoaming agents, and aliphatic acid ester-based defoaming agents are suitable. These defoaming agents can be used alone or in combination. Of these defoaming agents, silicone-based defoaming agents are preferable to easily break foams.

### <Preservatives and Fungicides>

The preservatives and fungicides are not particularly limited. A specific example is 1,2-benzisothiazolin-3-on.

### <Corrosion Inhibitor>

The corrosion inhibitor has no particular limit. Examples thereof are acid sulfite and sodium thiosulfate.

### <pH Regulator>

The pH regulator has no particular limit. It is preferable to adjust the pH to 7 or higher. Specific examples thereof include, but are not limited to, amines such as diethanol amine and triethanol amine.

The property of the ink is not particularly limited and can be suitably selected to suit to a particular application. For example, viscosity, surface tension, pH, etc., are preferably in the following ranges.

The viscosity of the ink at 25 degrees C. is preferably from 5 through 30 mPa·s and more preferably from 5 through 25 mPa·s to improve print density and text quality and obtain good dischargeability. The viscosity can be measured by, for example, a rotatory viscometer (RE-80L, manufactured by TOKI SANGYO CO., LTD.). The measuring conditions are as follows:
Standard cone rotor (1° 34′×R24)
Sample liquid amount: 1.2 mL
Number of rotations: 50 rotations per minute (rpm)
25 degrees C.
Measuring time: three minutes

The surface tension of the ink is preferably 35 mN/m or less and more preferably 32 mN/m or less at 25 degrees C. in terms that the ink is suitably levelized on a print medium and the drying time of the ink is shortened.

The pH of the ink is preferably from 7 through 12 and more preferably from 8 through 11 in terms of prevention of corrosion of metal materials contacting the ink.

### <Print Medium>

The print medium for use in printing is not particularly limited. Specific examples thereof include, but are not limited to, plain paper, gloss paper, special paper, cloth, film, OHP sheets, printing paper for general purpose.

It is effective to use the ink of the present disclosure on highly glossy paper that includes a coated layer on a support including cellulose pulp, because glossiness greater than the glossiness of the paper can be obtained. Specifically, printing paper LUMI ART GLOSS 130 GSM (available from Stora Enso Oyj, with 60 degree glossiness of 26.5) is preferable. Surface roughness of the printing paper is 7.0 [μm] or greater but 10 [μm] or less. When a solid image is formed on this print medium in a manner that the ink is attached in an amount of from 500 mg through 700 mg/A4, the surface roughness Ra of the solid image is 6.0 [μm] or greater but 7.5 [μm] or less. This provides the image with a good glossiness and a good fixability.

In this case, printing is performed in a manner that an inkjet printer IPSIO GX5500 (available from Ricoh Company, Ltd.) is loaded with the printing ink, LUMI ART GLOSS 130 GSM paper (available from Stora Enso Oyj) is set in the inkjet printer, and an image is solidly printed at a resolution of 1,200 dpi, dried at 100 degrees C. for 1 minute, and left to stand at room temperature for 24 hours. The surface roughness of the print medium and the image is measured with LEXT OLS4100 (available from Olympus Corporation) under the conditions that a measuring length is 2.5 mm and a cutoff value is 0.8 mm.

### <Printed Matter>

The ink printed matter of the present disclosure includes a print medium and an image formed on the print medium with the ink of the present disclosure.

An inkjet printing device and an inkjet printing method are used to print the image on the print medium to obtain the printed matter.

### <Printing Device and Printing Method>

The printing device of the present disclosure includes an ink discharging unit configured to discharge (jet) the ink of the present disclosure from a printing head (jetting head) to print an image on a print medium. The printing method of the present disclosure includes an ink discharging step of applying a stimulus to the ink of the present disclosure via an ink discharging unit to discharge the ink from a printing head to print an image on a print medium.

The ink of the present disclosure can be suitably applied to various printing devices employing an inkjet printing method such as printers, facsimile machines, photocopiers, multifunction peripherals (serving as a printer, a facsimile machine, and a photocopier), and 3D model manufacturing devices (3D printers, additive manufacturing device).

In the present disclosure, the printing device and the printing method represent a device capable of discharging ink, various processing fluids, etc. to a print medium and a method printing an image on the print medium using the device. The print medium means an article to which the ink or the various processing fluids can be attached at least temporarily.

The printing device may further optionally include a device relating to feeding, conveying, and ejecting the print medium and other devices referred to as a pre-processing device, a post-processing device, etc. in addition to the head portion to discharge the ink.

The printing device and the printing method may further optionally include a heater for use in the heating process and a drier for use in the drying process. For example, the heating device and the drying device heat and dry the top surface and the bottom surface of a print medium having an image. The heating device and the drying device are not particularly limited. For example, a fan heater and an infra-red heater can be used. The print medium can be heated and dried before, during, and after printing.

In addition, the printing device and the printing method are not limited to those producing merely meaningful visible images such as texts and figures with the ink. For example, the printing device and the printing method can produce patterns like geometric design and 3D images.

In addition, the printing device includes both a serial type device in which the liquid discharging head is caused to move and a line type device in which the liquid discharging head is not moved, unless otherwise specified.

Furthermore, in addition to the desktop type, this printing device includes a wide type capable of printing images on a large print medium such as AO, a continuous printer capable of using continuous paper wound up in a roll form as print media.

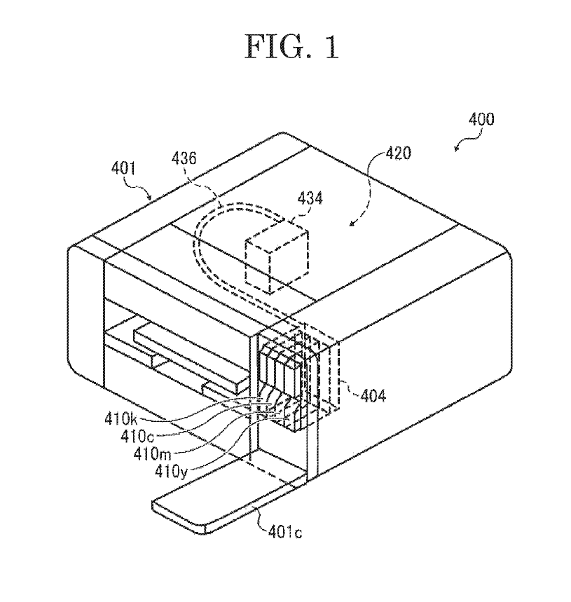

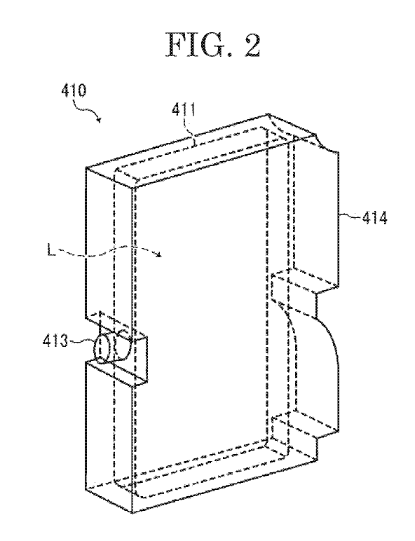

The printing device of the present disclosure is described using an example with reference to FIG. 1 and FIG. 2. FIG. 1 is a perspective view illustrating the printing device. FIG. 2 is a perspective view illustrating the main tank. An image forming apparatus 400 as an example of the printing device is a serial type image forming apparatus. A mechanical unit 420 is disposed in an exterior 401 of the image forming apparatus 400. Each ink container 411 of each main tank 410 (410k, 410c, 410m, and 410y) for each color of black (K), cyan (C), magenta (M), and yellow (Y) is made of a packing member such as aluminum laminate film. The ink container 411 is accommodated in a plastic housing unit 414. As a result, the main tank 410 is used as an ink cartridge of each color.

A cartridge holder 404 is disposed on the rear side of the opening when a cover 401c of the main body is opened. The cartridge holder 404 is detachably attached to the main tank 410. As a result, each ink discharging outlet 413 of the main tank 410 is communicated with a discharging head 434 for each color via a supplying tube 436 for each color so that the ink can be discharged from the discharging head 434 to a print medium.

How to use the ink is not limited to the inkjet printing method. Specific examples of such methods other than the inkjet printing method include, but are not limited to, blade coating methods, gravure coating methods, bar coating methods, roll coating methods, dip coating methods, curtain coating methods, slide coating methods, die coating methods, and spray coating methods.

### Examples

The present disclosure will be described more specifically below by way of Examples. The present disclosure should not be construed as being limited to Examples described below.

### <Pigment Dispersion PD-C>

A self-dispersible pigment dispersion was produced in the same manner as a method described in Japanese Unexamined Patent Application Publication No 2012-207202, [Pigment surface reforming treatment], —Method A—. Pigment blue 15:3 (available from Dainichiseika Color & Chemicals Mfg. Co., Ltd., CHROMOFINE BLUE) (20 g), a compound represented by structural formula (1) below (20 mmol), and ion-exchanged highly pure water (200 mL) were mixed in a room temperature environment with a SILVERSON mixer (6,000 rpm). When it was the case that the obtained slurry had pH of higher than 4, nitric acid (20 mmol) was to be added to the slurry. Thirty minutes later, sodium nitrite (20 mmol) dissolved in a small amount of ion-exchanged highly pure water was slowly added to the mixture. Under stirring, the mixture was heated to 60 degrees C. and allowed to undergo a reaction for 1 hour, to produce a reformed pigment in which the compound represented by structural formula (1) below was added to the pigment blue. Then, the reformed pigment was adjusted to pH of 10 with a NaOH aqueous solution, to obtain a reformed pigment dispersion 30 minutes later. The dispersion including the pigment bound with at least 1 geminal bisphosphonic acid group or sodium geminal bisphosphonate and ion-exchanged highly pure water were subjected to ultrafiltration through a dialysis membrane and further subjected to ultrasonic dispersion, to obtain a cyan pigment dispersion [PD-C] having a pigment concentration of 15 percent by mass.

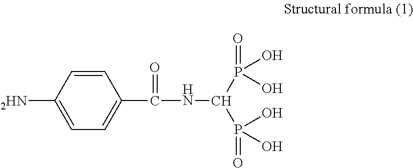

### <Pigment Dispersion PD-M>

A magenta pigment dispersion [PD-M] having a pigment concentration of 15 percent by mass was obtained in the same method as the method for producing the pigment dispersion [PD-C], except that the pigment blue (20 g) used in the method for producing the pigment dispersion [PD-C] was changed to pigment red 122 (available from Clariant Japan Co., Ltd., TONER MAGENTA EO02) (20 g).

### <Pigment Dispersion PD-Y>

A yellow pigment dispersion [PD-Y] having a pigment concentration of 15 percent by mass was obtained in the same method as the method for producing the pigment dispersion [PD-C], except that the pigment blue (20 g) used in the method for producing the pigment dispersion [PD-C] was changed to pigment yellow 74 (available from Dainichiseika Color & Chemicals Mfg. Co., Ltd., FAST YELLOW 531) (20 g).

### <Other Materials>

Acrylic resins Ac-1 through 2 and urethane resins Ur-1 through 5 used in Examples and Comparative Examples are presented below.

### <Resin Ac-1>

Acrylic silicone resin

SYMAC US480 (available from Toagosei Co., Ltd.)

### <Resin Ac-2>

Styrene acrylic resin

POLYSOL AP-1120 (available from Showa Kobunshi Co., Ltd.)

### <Resin Ur-1>

Polycarbonate-based resin

TAKELAC W6110 (available from Mitsui Chemicals, Inc.)

### <Resin Ur-2>

Polycarbonate-based resin

TAKELAC W6061 (available from Mitsui Chemicals, Inc.)

### <Resin Ur-3>

Polyether-based resin

TAKELAC W5661 (available from Mitsui Chemicals, Inc.)

### <Resin Ur-4>

Polycarbonate-based resin

TAKELAC W6010 (available from Mitsui Chemicals, Inc.)

### <Resin Ur-5>

Ester/ether-based urethane resin

SUPERFLEX 300 (available from DKS Co., Ltd.)

Organic solvents Os-1 through 8 used in Examples and Comparative Examples are presented below.

### <Organic Solvent Os-1>

N,N-dimethyl-β-butoxypropionamide represented by structural formula (2) below (B100 available from Idemitsu Kosan Co., Ltd.)

Total HSP value: 20.2

Polarity HSP value: 8.9

Boiling point: 252 degrees C.

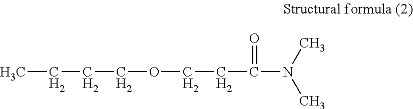

### <Organic Solvent Os-2>

3-Ethyl-3-hydroxymethyloxetane represented by structural formula (3) below (EHO available from Ube Industries, Ltd.)

Total HSP value: 22.6

Polarity HSP value: 7.9

Boiling point: 227 degrees C.

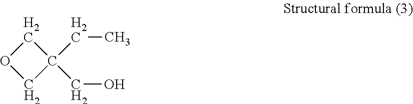

### <Organic Solvent Os-3>

1,2-Butanediol (available from Shinko Organic Chemical Industry Ltd.)

Total HSP value: 26.9

Polarity HSP value: 8.2

Boiling point: 195 degrees C.

### <Organic Solvent Os-4>

N,N-dimethyl-β-methoxypropionamide represented by structural formula (4) below (M100 available from Idemitsu Kosan Co., Ltd.)

Total HSP value: 22.5

Polarity HSP value: 11.0

Boiling point: 216 degrees C.

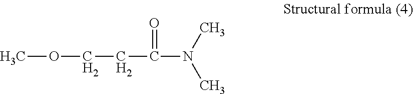

### <Organic Solvent Os-5>

1,3-Butanediol (available from Tokyo Chemical Industry Co., Ltd.)

Total HSP value: 27.8

Polarity HSP value: 8.1

Boiling point: 204 degrees C.

### <Organic Solvent Os-6>

1,3-Propanediol (available from Tokyo Chemical Industry Co., Ltd.)

Total HSP value: 31.7

Polarity HSP value: 13.5

Boiling point: 214 degrees C.

### <Organic Solvent Os-7>

1,2-Propanediol (available from ADEKA Corporation)

Total HSP value: 29.1

Polarity HSP value: 10.4

Boiling point: 188 degrees C.

### <Organic Solvent Os-8>

1-Methoxy-2-propanol (available from Tokyo Chemical Industry Co., Ltd.)

Total HSP value: 20.4

Polarity HSP value: 6.3

Boiling point: 121 degrees C.

Surfactants S-1 through 3 used in Examples and Comparative Examples are presented below.

### <Surfactant S-1>

Polyether-modified siloxane polymer

TEGO WET 270 (available from Evonik Industries AG)

### <Surfactant S-2>

Nonionic surfactant

SURFYNOL 465 (available from Air Products and Chemicals, Inc.)

### <Surfactant S-3>

Fluorosurfactant

DSN403N (available from DAIKIN INDUSTRIES)

The materials presented above are listed in Tables 1-1 to 1-4.

TABLE 1-1

| | Name | Kind of pigment |
|---|---|---|
| Pigment | PD-Bk | Carbon black (available from |
| dispersion | | Degussa AG, NIPEX 160) |
| | PD-C | Pigment blue 15:3 (available |
| | | from Dainichiseika Color & |
| | | Chemicals Mfg. Co., |
| | | Ltd., CHROMOFINE BLUE) |
| | PD-M | Pigment red 122 (available |
| | | from Clariant Japan |
| | | Co., Ltd., TONER |
| | | MAGENTA EO02) |
| | PD-Y | Pigment yellow 74 (available |
| | | from Dainichiseika Color & |
| | | Chemicals Mfg. Co., Ltd., |
| | | FAST YELLOW 531) |

TABLE 1-2

| | | | HSP | HSP | Boiling |
|---|---|---|---|---|---|
| | | | value | value | point |
| | Name | Kind of solvent | (total) | (polarity) | (degree C.) |
| Organic | Os-1 | N,N-dimethyl-β- | 20.2 | 8.9 | 252 |
| solvent | | butoxypropionamide | | | |
| | Os-2 | 3-ethyl-3- | 22.6 | 7.9 | 227 |
| | | hydroxymethyloxetane | | | |
| | Os-3 | 1,2-butanediol | 26.9 | 8.2 | 195 |
| | Os-4 | N,N-dimethyl-β- | 22.5 | 11 | 216 |
| | | ethoxypropionamide | | | |
| | Os-5 | 1,3-butanediol | 27.8 | 8.1 | 204 |
| | Os-6 | 1,3-propanediol | 31.7 | 13.5 | 214 |
| | Os-7 | 1,2-propanediol | 29.1 | 10.4 | 188 |
| | Os-8 | 1-methoxy-2-propanol | 20.4 | 6.3 | 121 |

TABLE 1-3

| | Name | Kind of resin |
|---|---|---|
| Resin | Ac-1 | SYMAC US480 (available from Toagosei Co., Ltd., |
| | | acrylic silicone) |
| | Ac-2 | POLYSOL AP-1120 (available from Showa Kobunshi Co., |
| | | Ltd., styrene acrylic) |
| | Ur-1 | TAKELAC W6110 (available from Mitsui Chemicals Inc., |
| | | polycarbonate-based urethane) |
| | Ur-2 | TAKELAC W6061 (available from Mitsui Chemicals Inc., |
| | | polycarbonate-based urethane) |
| | Ur-3 | TAKELAC W5661 (available from Mitsui Chemicals Inc., |
| | | polyether-based urethane) |
| | Ur-4 | TAKELAC W6010 (available from Mitsui Chemicals Inc., |
| | | polycarbonate-based urethane) |
| | Ur-5 | SUPERFLEX 300 (available from DKS Co., Ltd., |
| | | ester/ether-based urethane) |

TABLE 1-4

| | Name | Kind of surfactant |
|---|---|---|
| Surfactant | S-1 | TEGO WET 270 |
| | S-2 | SURFYNOL 465 |
| | S-3 | DSN403N |

### <Preparation of Cyan, Magenta, and Yellow Inks>

The materials prescribed in Table 2 below were mixed and stirred, and then filtrated through a 0.2 μm polypropylene filter, to produce inks of Examples 1 to 11 and Comparative Examples 1 to 8. The kinds of the pigment dispersions, the organic solvents, and the resin particles used in the inks and the mixing ratios of the organic solvents are as presented in the fields of each of Examples and Comparative Examples. The values in Table 2 are in the unit “percent by mass”.

Note that a leveling agent (DSN403N) was added in Comparative Example 8.

TABLE 2

| | | | | | | | | | Resin | | | | | Others | | | | |
|---|---|---|---|---|---|---|---|---|---|---|---|---|---|---|---|---|---|---|
| | Pigment | | Organic solvent | | | | | | Resin 1 | | Resin 2 | | Urethane/ | Surfactant | | Surfactant | | |
| | dispersion | | Solvent 1 | | Solvent 2 | | Solvent 3 | | (urethane) | | (acrylic) | | acrylic | 1 | | 2 | | Water |
| Ex. 1 | PD-C | 15 | Os-1 | 30 | Os-7 | 16 | — | — | Ur-1 | 3 | Ac-1 | 13 | 0.23 | S-1 | 2 | — | — | 21 |
| Ex. 2 | PD-M | 30 | Os-1 | 32 | Os-7 | 10 | — | — | Ur-1 | 3 | Ac-1 | 11 | 0.27 | S-1 | 2 | — | — | 12 |
| Ex. 3 | PD-Y | 20 | Os-1 | 31 | Os-7 | 10 | — | — | Ur-1 | 4 | Ac-1 | 17 | 0.24 | S-1 | 2 | — | — | 16 |
| Ex. 4 | PD-C | 15 | Os-1 | 30 | Os-7 | 16 | — | — | Ur-1 | 3 | Ac-2 | 13 | 0.23 | S-1 | 2 | — | — | 21 |
| Ex. 5 | PD-C | 15 | Os-2 | 26 | Os-4 | 20 | — | — | Ur-1 | 3 | Ac-1 | 13 | 0.23 | S-1 | 2 | — | — | 21 |
| Ex. 6 | PD-C | 15 | Os-1 | 30 | Os-7 | 16 | — | — | Ur-2 | 3 | Ac-1 | 13 | 0.23 | S-1 | 2 | — | — | 21 |
| Ex. 7 | PD-C | 15 | Os-2 | 30 | Os-5 | 10 | Os-7 | 3 | Ur-3 | 3 | Ac-2 | 13 | 0.23 | S-1 | 2 | — | — | 24 |
| Ex. 8 | PD-C | 15 | Os-3 | 30 | Os-7 | 13 | Os-8 | 3 | Ur-1 | 3 | Ac-1 | 13 | 0.23 | S-1 | 2 | — | — | 21 |
| Ex. 9 | PD-C | 15 | Os-1 | 30 | Os-7 | 16 | — | — | Ur-1 | 10 | Ac-1 | 6 | 1.67 | S-2 | 2 | — | — | 21 |
| Ex. 10 | PD-C | 15 | Os-1 | 30 | Os-7 | 16 | — | — | Ur-4 | 3 | Ac-1 | 13 | 0.23 | S-1 | 2 | — | — | 21 |
| Ex. 11 | PD-C | 15 | Os-1 | 30 | Os-7 | 16 | — | — | Ur-5 | 3 | Ac-1 | 13 | 0.23 | S-1 | 2 | — | — | 21 |
| Comp. | PD-C | 15 | Os-1 | 30 | Os-7 | 16 | — | — | — | — | Ac-1 | 16 | — | S-1 | 2 | — | — | 21 |
| Ex. 1 | | | | | | | | | | | | | | | | | | |
| Comp. | PD-C | 15 | Os-2 | 30 | Os-4 | 16 | — | — | Ur-1 | 16 | — | — | — | S-1 | 2 | — | — | 21 |
| Ex. 2 | | | | | | | | | | | | | | | | | | |
| Comp. | PD-C | 15 | Os-5 | 32 | Os-7 | 14 | — | — | Ur-1 | 3 | Ac-1 | 13 | 0.23 | S-1 | 2 | — | — | 21 |
| Ex. 3 | | | | | | | | | | | | | | | | | | |
| Comp. | PD-C | 15 | Os-6 | 28 | Os-3 | 18 | — | — | Ur-1 | 3 | Ac-1 | 13 | 0.23 | S-1 | 2 | — | — | 21 |
| Ex. 4 | | | | | | | | | | | | | | | | | | |
| Comp. | PDC | 15 | Os-7 | 30 | Os-8 | 16 | — | — | Ur-1 | 3 | Ac-1 | 13 | 0.23 | S-1 | 2 | — | — | 21 |
| Ex. 5 | | | | | | | | | | | | | | | | | | |
| Comp. | PD-C | 15 | Os-4 | 26 | Os-7 | 20 | — | — | Ur-1 | 3 | Ac-1 | 13 | 0.23 | S-1 | 2 | — | — | 21 |
| Ex. 6 | | | | | | | | | | | | | | | | | | |
| Comp. | PD-C | 15 | Os-4 | 26 | Os-7 | 20 | — | — | Ur-2 | 3 | Ac-1 | 13 | 0.23 | S-1 | 2 | — | — | 21 |
| Ex. 7 | | | | | | | | | | | | | | | | | | |
| Comp. | PD-C | 15 | Os-6 | 28 | Os-3 | 18 | — | — | Ur-1 | 3 | Ac-1 | 13 | 0.23 | S-1 | 1 | S-3 | 1 | 21 |
| Ex. 8 | | | | | | | | | | | | | | | | | | |

The inks prepared in the manner described above were evaluated in terms of the following evaluation items. The results are presented in Tables 3-1 to 3-3 and Table 4.

### <Surface Roughness>

An inkjet printer IPSIO GX5500 (available from Ricoh Company, Ltd.) was loaded with each of the printing inks of Examples and Comparative Examples. Next, LUMI ART GLOSS 130 GSM (available from Stora Enso Oyj, with a 60 degree glossiness of 26.5) was set, and a solid image was printed in a manner that the ink was attached in an amount of from 500 mg through 700 mg/A4 and the resolution was 1,200 dpi. The image was dried at 100 degrees C. for 1 minute and then left to stand at room temperature for 24 hours.

The surface roughness Ra of the print medium before printed was 7.3 [μm]. The surface roughness Ra was measured according to a method specified in JISB-0601. LEXT OLS4100 (available from Olympus Corporation) was used for the measurement. A measuring length was 2.5 mm and a cutoff value was 0.8 mm.

The surface roughness Ra of the obtained image was measured according to the same method as for the measurement of the surface roughness of the print medium.

### <Glossiness>

Sixty degree glossiness of the obtained image was measured with a glossmeter (available from BYK Gardner GmbH, MICRO-TRI-GLOSS 4520). The evaluation criteria are as follows.

### [Evaluation Criteria]

A: 30 or greater

B: Less than 30

### <Scratch Resistance>

The printed portion of the obtained image was scratched 20 times with LUMI ART GLOSS 130 GSM paper cut into a size of 1.2 cm×1.2 cm. Stains on the paper by ink attachment were measured with a reflective color spectrophotometric densitometer (available from X-Rite Inc.). The density of the stains calculated by subtracting the background color of the scratching paper was evaluated according to the criteria described below.

### [Evaluation Criteria]

A: The transfer density was less than 0.10.

B: The transfer density was 0.10 or greater.

### <Blocking Resistance>

Two printed matters were produced according to the above-described printing manner. The obtained images were overlapped with each other and left to stand under a pressure of 5 kg/cm² for 24 hours, and the degrees of how much the printed matters stuck to each other and how much the images were transferred to each other were confirmed. The same evaluation was conducted for printed matters produced according to the above-described printing manner in which the drying conditions were changed to 100 degrees C. for 5 seconds. A grade of B or greater is a tolerable level.

### [Evaluation Criteria]

A: Neither the printed matters stuck to each other nor the images were transferred to each other.

B: The printed matters stuck to each other but the images were not transferred to each other.

C: The printed matters stuck to each other and the images were transferred to each other.

### <Discharging Reliability>

With an inkjet printer (IPSIO GX-E5500 (available from Ricoh Company, Ltd.)) in which each of the inks obtained in Examples 5, 7, and 8 and Comparative Example 6 was loaded and set, continuous printing was performed for 10 minutes. Then, the printer was left to stand in an environment in which a temperature was 50 degrees C. and a humidity was 60 percent RH for 1 month with a surface of a head capped for moisture retention in a state that the ink adhered to the surface of the head. After this, the printer was cleaned and restored to the same state as before the printer was left to stand. After this, an intermittent printing test was performed under the conditions described below to evaluate discharging reliability (discharging stability).

Specifically, a print pattern chart was printed on 20 sheets continuously, and the printer was brought into a suspension state in which no printing was performed for 20 minutes. This process was repeated 50 times to print a total of 1,000 sheets. After this, the same chart was printed on one more sheet. Presence or absence of streak, white void, and jetting disorder on a 5 percent chart solid portion of the sheet was visually evaluated according to the criteria described below. In the print pattern chart, a print area of each color was 5 percent of the whole area of the sheet surface, and each ink was printed at a hundred percent duty. Printing conditions include a print density of 600×300 dpi and one-pass printing.

The evaluation results are presented in Table 4. The grades A and B are tolerable levels.

### [Evaluation Criteria]

A: There were no streak, white void, and jetting disorder on the solid portion.

B: Streak, white void, and jetting disorder were slightly recognized on the solid portion.

C: Streak, white void, and jetting disorder were recognized on the solid portion.

D: Streak, white void, and jetting disorder were recognized all over the solid portion.

The results are presented in Tables 3-1 to 3-3 and Table 4. The unit of the HSP values in Tables is [(J/cm³)^{0.5}].

TABLE 3-1

| | Prescription | | | | | |
|---|---|---|---|---|---|---|
| | Resin ratios | | | | | Organic |
| | Urethane | Ratio | Acrylic | Ratio | Dispersion | solvent |
| Ex. 1 | W6110 | 20 | US480 | 80 | C | 1, 7 |
| Ex. 2 | W6110 | 20 | US480 | 80 | M | 1, 7 |
| Ex. 3 | W6110 | 20 | US480 | 80 | Y | 1, 7 |
| Ex. 4 | W6110 | 20 | AP-1120 | 80 | C | 1, 7 |
| Ex. 5 | W6110 | 20 | US480 | 80 | C | 2, 4 |
| Ex. 6 | W6061 | 20 | US480 | 80 | C | 1, 7 |
| Ex. 7 | W5661 | 20 | AP-1120 | 80 | C | 2, 5, 7 |
| Ex. 8 | W6110 | 20 | US480 | 80 | C | 3, 7, 8 |
| Ex. 9 | W6110 | 60 | US480 | 40 | C | 1, 7 |
| Ex. 10 | W6010 | 20 | US480 | 80 | C | 1, 7 |
| Ex. 11 | SUPERFLEX | 20 | US480 | 80 | C | 1, 7 |
| | 300 | | | | | |
| Comp. Ex. 1 | — | 0 | US480 | 100 | C | 1, 7 |
| Comp. Ex. 2 | W6110 | 100 | — | 0 | C | 2, 4 |
| Comp. Ex. 3 | W6110 | 20 | US480 | 80 | C | 5, 7 |
| Comp. Ex. 4 | W6110 | 20 | US480 | 80 | C | 6, 3 |
| Comp. Ex. 5 | W6110 | 20 | US480 | 80 | C | 7, 8 |
| Comp. Ex. 6 | W6110 | 20 | US480 | 80 | C | 4, 7 |
| Comp. Ex. 7 | W6061 | 20 | US480 | 80 | C | 4, 7 |
| Comp. Ex. 8 | W6110 | 20 | US480 | 80 | C | 6, 3 |

TABLE 3-2

| | HSP value | | | | | | | | | |
|---|---|---|---|---|---|---|---|---|---|---|
| | Urethane-based resin | | | | | | | | | |
| | | Urethane- | | | Urethane- | | | Acrylic-based resin | | |
| | Organic | based | | Organic | based | | Tg | Organic | Acrylic- | Differ- |
| | solvent | resin | Difference | solvent | resin | Difference | [degree | solvent | based | ence |
| | (total) | (total) | (total) | (polarity) | (polarity) | (polarity) | C.] | (total) | (total) | (total) |
| Ex. 1 | 20.2 | 20.8 | 0.6 | 8.9 | 4.3 | 4.6 | −20 | 20.2 | 25.0 | 4.8 |
| Ex. 2 | 20.2 | 20.8 | 0.6 | 8.9 | 4.3 | 4.6 | −20 | 20.2 | 25.0 | 4.8 |
| Ex. 3 | 20.2 | 20.8 | 0.6 | 8.9 | 4.3 | 4.6 | −20 | 20.2 | 25.0 | 4.8 |
| Ex. 4 | 20.2 | 20.8 | 0.6 | 8.9 | 4.3 | 4.6 | −20 | 20.2 | 24.8 | 4.6 |
| Ex. 5 | 22.6 | 20.8 | 1.8 | 7.9 | 4.3 | 3.6 | −20 | 22.6 | 25.0 | 2.4 |
| Ex. 6 | 20.2 | 22.2 | 2.0 | 8.9 | 5.1 | 3.8 | 25 | 20.2 | 25.0 | 4.8 |
| Ex. 7 | 22.6 | 24.9 | 2.3 | 7.9 | 4.7 | 3.2 | 70 | 22.6 | 24.8 | 2.2 |
| Ex. 8 | 26.9 | 20.8 | 6.1 | 8.2 | 4.3 | 3.9 | −20 | 26.9 | 25.0 | 1.9 |
| Ex. 9 | 20.2 | 20.8 | 0.6 | 8.9 | 4.3 | 4.6 | −20 | 20.2 | 25.0 | 4.8 |
| Ex. 10 | 20.2 | 21.5 | 1.3 | 8.9 | 4.8 | 4.1 | 90 | 20.2 | 25.0 | 4.8 |
| Ex. 11 | 20.2 | 24.3 | 4.1 | 8.9 | 4.9 | 4.0 | −40 | 20.2 | 25.0 | 4.8 |
| Comp. | — | — | — | — | — | — | — | 20.2 | 25.0 | 4.8 |
| Ex. 1 | | | | | | | | | | |
| Comp. | 20.2 | 20.8 | 0.6 | 8.9 | 4.3 | 4.6 | −20 | — | — | — |
| Ex. 2 | | | | | | | | | | |
| Comp. | 27.8 | 20.8 | 7.0 | 8.1 | 4.3 | 3.8 | −20 | 27.8 | 25.0 | 2.8 |
| Ex. 3 | | | | | | | | | | |
| Comp. | 31.7 | 20.8 | 10.9 | 13.5 | 4.3 | 9.2 | −20 | 31.7 | 25.0 | 6.7 |
| Ex. 4 | | | | | | | | | | |
| Comp. | 29.1 | 20.8 | 8.3 | 10.4 | 4.3 | 6.1 | −20 | 29.1 | 25.0 | 4.1 |
| Ex. 5 | | | | | | | | | | |
| Comp. | 22.5 | 20.8 | 1.7 | 11.0 | 4.3 | 6.7 | −20 | 22.5 | 25.0 | 2.5 |
| Ex. 6 | | | | | | | | | | |
| Comp. | 22.5 | 22.2 | 0.3 | 11.0 | 5.1 | 5.9 | 25 | 22.5 | 25.0 | 2.5 |
| Ex. 7 | | | | | | | | | | |
| Comp. | 31.7 | 20.8 | 10.9 | 13.5 | 4.3 | 9.2 | −20 | 31.7 | 25.0 | 6.7 |
| Ex. 8 | | | | | | | | | | |

TABLE 3-3

| | Image evaluation | | | | | |
|---|---|---|---|---|---|---|
| | | | | | Blocking resistance | |
| | | | | | 100 | 100 |
| | Surface | | | | degrees | degrees |
| | roughness | 60 degree | | Scratch | C., | C., |
| | Ra | glossiness | | resistance | 1 minute | 5 seconds |
| Ex. 1 | 6.6 | 38 | A | A | A | A |
| Ex. 2 | 6.3 | 38 | A | A | B | B |
| Ex. 3 | 6.5 | 37 | A | A | A | A |
| Ex. 4 | 7.0 | 35 | A | A | A | A |
| Ex. 5 | 6.8 | 37 | A | A | A | A |
| Ex. 6 | 6.9 | 35 | A | A | A | A |
| Ex. 7 | 7.1 | 35 | A | A | A | B |
| Ex. 8 | 7.5 | 32 | A | A | A | A |
| Ex. 9 | 6.5 | 36 | A | A | B | B |
| Ex. 10 | 7.3 | 34 | A | A | B | B |
| Ex. 11 | 7.5 | 32 | A | A | B | B |
| Comp. Ex. 1 | 8.2 | 33 | A | B | A | A |
| Comp. Ex. 2 | 7.8 | 26 | B | A | C | C |
| Comp. Ex. 3 | 7.7 | 22 | B | A | A | A |
| Comp. Ex. 4 | 7.8 | 24 | B | A | A | A |
| Comp. Ex. 5 | 7.7 | 25 | B | A | A | A |
| Comp. Ex. 6 | 7.7 | 25 | B | A | A | A |
| Comp. Ex. 7 | 7.7 | 24 | B | A | A | A |
| Comp. Ex. 8 | 7.6 | 27 | B | A | A | A |

TABLE 4

| | | | HSP | HSP distance be- | |
|---|---|---|---|---|---|
| | | | distance | tween any of sol- | Dis- |
| | Sol- | Sol- | between | vents 1 and 2 having | charging |
| | vent | vent | solvent 1 | greater total HSP | reliability |
| | 1 | 2 | and solvent 2 | value and water | rank |
| Ex. 5 | Os-2 | Os-4 | 4.24 | 31.46 | A |
| Ex. 7 | Os-2 | Os-5 | 3.05 | 22.9 | A |
| Ex. 8 | Os-3 | Os-7 | 8.62 | 21.89 | A |
| Comp. | Os-4 | Os-7 | 11.84 | 21.89 | C |
| Ex. 6 | | | | | |

As presented in Tables 3-1 to 3-3, in Examples 1 to 7, the surface roughness Ra was within the specified range, a better glossiness than when acrylic was used alone (Comparative Example 1) was exhibited, and the differences between the HSP values of the resins and the organic solvent were also within the specified ranges.

In Example 8, the surface roughness Ra was within the specified range, an equal level of glossiness to when acrylic was used alone (Comparative Example 1) was exhibited, and the differences between the HSP values of the resins and the organic solvent were also within the specified ranges.

In Example 9, the surface roughness Ra was within the specified range, a better glossiness than when acrylic was used alone (Comparative Example 1) was exhibited, and the differences between the HSP values of the resins and the organic solvent were also within the specified ranges. However, the ratio of the urethane resin was greater than the ratio of the acrylic resin, which led to increase in tackiness to result in a slightly poor blocking resistance.

In Examples 10 and 11, the blocking resistance was slightly poor because the glass transition temperature Tg of the urethane-based resin particles was outside the preferable range.

Comparative Example 1 in which an acrylic resin was used alone resulted in a good glossiness but in a poor scratch resistance. Comparative Example 2 in which a urethane resin was used alone resulted in a poor glossiness and also in a poor blocking resistance. Comparative Examples 3 to 7 resulted in a surface roughness Ra outside the specified range and in a glossiness equal to or poorer than when a urethane resin was used alone (Comparative Example 2). Comparative Example 8 in which a surfactant having an excellent leveling property was added resulted in a slightly better glossiness, which however was an equal level to when a urethane resin was used alone (Comparative Example 2) and poorer than when an acrylic resin was used alone (Comparative Example 1).

From Table 4, Comparative Example 6 in which the HSP distance between the solvent 1 and the solvent 2 did not satisfy the specified range resulted in a poor discharging reliability rank.

What is claimed is:

1. An ink comprising:
water;
at least one organic solvent;
a coloring material;
urethane-based resin particles; and
acrylic-based resin particles,
wherein a difference between a total HSP value of an organic solvent having a highest boiling point of the at least one organic solvent and a total HSP value of the urethane-based resin particles is 6.0 [(J/cm³)^{0.5}] or less, and
wherein a difference between a polarity HSP value of the organic solvent having the highest boiling point of the at least one organic solvent and a polarity HSP value of the urethane-based resin particles is 5.0 [(J/cm³)^{0.5}] or less.

2. The ink according to claim 1,
wherein a difference between the total HSP value of the organic solvent having the highest boiling point of the at least one organic solvent and a total HSP value of the acrylic-based resin particles is 5.0 [(J/cm³)^{0.5}] or less.

3. An ink comprising:
water;
at least one organic solvent;
a coloring material;
urethane-based resin particles; and
acrylic-based resin particles, and
wherein a solid image formed with the ink has a surface roughness Ra of 6.0 [μm] or greater but 7.5 [μm] or less when formed in a manner that the ink is attached in an amount of from 500 mg through 700 mg/A4 on a print medium that includes a coated layer on a support including cellulose pulp and has a surface roughness of 7.0 [μm] or greater but 10.0 [μm] or less.

4. The ink according to claim 1,
wherein a proportion of the acrylic-based resin particles in the ink is greater than a proportion of the urethane-based resin particles in the ink.

5. The ink according to claim 4,
wherein a ratio (the proportion of the urethane-based resin particles/the proportion of the acrylic-based resin particles) of the proportion of the urethane-based resin particles to the proportion of the acrylic-based resin particles is from 0.1 through 0.7 when expressed in a ratio by mass between solid proportions.

6. The ink according to claim 1,
wherein the urethane-based resin particles have a glass transition temperature Tg of −20 [degrees C.] or higher but 70 [degrees C.] or lower.

7. The ink according to claim 6,
wherein the urethane-based resin particles have a glass transition temperature Tg of −20 [degrees C.] or higher but 25 [degrees C.] or lower.

8. The ink according to claim 3,
wherein a proportion of the acrylic-based resin particles in the ink is greater than a proportion of the urethane-based resin particles in the ink.

9. The ink according to claim 8,
wherein a ratio (the proportion of the urethane-based resin particles/the proportion of the acrylic-based resin particles) of the proportion of the urethane-based resin particles to the proportion of the acrylic-based resin particles is from 0.1 through 0.7 when expressed in a ratio by mass between solid proportions.

10. The ink according to claim 3,
wherein the urethane-based resin particles have a glass transition temperature Tg of −20 [degrees C.] or higher but 70 [degrees C.] or lower.

11. The ink according to claim 1,
wherein the at least one organic solvent comprises two or more organic solvents,
wherein when an organic solvent having a lowest total HSP value of the two or more organic solvents is assumed as a solvent A and an organic solvent having a second lowest total HSP value to the solvent A is assumed as a solvent B, a HSP distance between the solvent A and the solvent B calculated according to a formula below is 9 or less, and a HSP distance between the water and the solvent B calculated according to the formula below is 32 or less:
Rₐ=(4(δ_{D2}−δ_{D1})²+(δ_{P2}−δ_{P1})²+(δ_{H2}−δ_{H1})²)^{0.5}
where symbols in the formula are as follows:
Ra: a HSP distance
δ_{D2}: a HSP value of the solvent B other than polarity HSP value
δ_{D1}: a HSP value of the solvent A (or the water) other than a polarity HSP value
δ_{P2}: a polarity HSP value of the solvent B
δ_{P1}: a polarity HSP value of the solvent A (or the water)
δ_{H2}: a hydrogen bond HSP value of the solvent B
δ_{H1}: a hydrogen bond HSP value of the solvent A (or the water).

12. The ink according to claim 1,
wherein the at least one organic solvent comprises one or more selected from the group consisting of N,N-dimethyl-β-butoxypropionamide, N,N-dimethyl-β-methoxypropionamide, 3-ethyl-3-hydroxymethyloxetane, and propylene glycol monomethyl ether.

13. A printed matter comprising:
a print medium; and
an image formed on the print medium with an ink,
wherein the ink comprises:
water;
at least one organic solvent;
a coloring material;
urethane-based resin particles; and
acrylic-based resin particles,
wherein a difference between a total HSP value of an organic solvent having a highest boiling point of the at least one organic solvent and a total HSP value of the urethane-based resin particles is 6.0 [(J/cm³)^{0.5}] or less, and
wherein a difference between a polarity HSP value of the organic solvent having the highest boiling point of the at least one organic solvent and a polarity HSP value of the urethane-based resin particles is 5.0 [(J/cm³)^{0.5}] or less.

14. An ink stored container comprising:
the ink according to claim 1; and
a container storing the ink.

15. A printing apparatus comprising
an ink discharging unit configured to discharge the ink according to claim 1 from a printing head to print an image on a print medium.

16. A printing method comprising
applying a stimulus to the ink according to claim 1 via an ink discharging unit to discharge the ink from a printing head to print an image on a print medium.

17. A printed matter comprising:
a print medium; and
an image formed on the print medium with the ink according to claim 3.

18. An ink stored container comprising:
the ink according to claim 3; and
a container storing the ink.

19. A printing apparatus comprising
an ink discharging unit configured to discharge the ink according to claim 3 from a printing head to print an image on a print medium.

20. A printing method comprising
applying a stimulus to the ink according to claim 3 via an ink discharging unit to discharge the ink from a printing head to print an image on a print medium.
